(19) United States
(12) Patent Application Publication
(10) Pub. No.: US 2008/0313300 A1
(43) Pub. Date: Dec. 18, 2008

(54) METHOD AND APPARATUS FOR PROVIDING SYSTEM INFORMATION

(76) Inventors: Seppo M. Alanara, Oulu (FI); Jarkko J. Koskela, Oulu (FI); Juha T. Kinnunen, Oulu (FI)

Correspondence Address: DITTHAVONG MORI & STEINER, P.C., 918 Prince Street, Alexandria, VA, 22314, US

(21) Appl. No.: 12/141,648

(22) Filed: Jun. 18, 2008

Related U.S. Application Data
(60) Provisional application No. 60/944,677, filed on Jun. 18, 2007.

(51) Int. Cl. G06F 15/16; G06F 1/26; G06F 15/177

(52) U.S. Cl. 709/208; 713/340; 709/220

(57) ABSTRACT

An approach is provided for distributing system information. A determination is made whether repetition rate associated with system information exceeds a predetermined threshold. The repetition rate specifies frequency of transmission of the system information to a terminal over a network. The scheduling information for the system information is transmitted to the terminal if the threshold is satisfied.

### RELATED APPLICATIONS

This application claims the benefit of the earlier filing date under 35 U.S.C. §119(e) of U.S. Provisional Application Ser. No. 60/944,677 filed Jun. 18, 2007, entitled “Method and Apparatus for Providing System Information,” the entirety of which is incorporated herein by reference.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves control signaling to ensure efficient delivery of data.

### SOME EXEMPLARY EMBODIMENTS

Therefore, there is a need for an approach for providing efficient signaling, which can co-exist with already developed standards and protocols.

According to one embodiment of the invention, a method comprises determining whether repetition rate associated with system information exceeds a predetermined threshold, the repetition rate specifying frequency of transmission of the system information to a terminal over a network. The scheduling information for the system information is transmitted to the terminal if the threshold is satisfied.

According to another embodiment of the invention, an apparatus comprises logic configured to determine whether repetition rate associated with system information exceeds a predetermined threshold. The repetition rate specifies frequency of transmission of the system information to a terminal over a network. The scheduling information for the system information is transmitted to the terminal if the threshold is satisfied.

According to another embodiment of the invention, a method comprises transmitting power information over a network to a base station. The method also comprises receiving scheduling information for system information, wherein repetition rate associated with system information exceeds a predetermined threshold that is set based on a power saving analysis using the power information.

According to another embodiment of the invention, an apparatus comprises logic configured to generate power information for transmission over a network to a base station, wherein scheduling information for system information is received, and repetition rate associated with system information exceeds a predetermined threshold that is set based on a power saving analysis using the power information.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

(FIG. 1 is a diagram of a communication system capable of system information, according to an exemplary embodiment;

FIG. 2 is a diagram of a control message specifying scheduling information associated with system information, according to an exemplary embodiment;

FIG. 3 is a flowchart of a process for transmitting system information based on repetition rate, according to an exemplary embodiment;

FIG. 4 is a flowchart of a process for collecting power information to set a repetition rate threshold, according to an exemplary embodiment;

FIG. 5 is a flowchart of a process for creating a scheduling list relating to transmission of system information, according to an exemplary embodiment;

FIGS. 6A-6D are diagrams of communication systems having exemplary long-term evolution (LTE) and E-UTRA (Evolved Universal Terrestrial Radio Access) architectures, in which the system of FIG. 1 can operate to provide resource allocation, according to various exemplary embodiments of the invention;

FIG. 7 is a diagram of hardware that can be used to implement an embodiment of the invention; and

FIG. 8 is a diagram of exemplary components of a user terminal configured to operate in the systems of FIGS. 6A-6D, according to an embodiment of the invention.

### DESCRIPTION OF PREFERRED EMBODIMENT

An apparatus, method, and software for providing system information signaling are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless network compliant with the Third Generation Partnership Project (3GPP) Long Term Evolution (LTE) architecture, it is recognized by one of ordinary skill in the art that the embodiments of the inventions have applicability to any type of communication system and equivalent functional capabilities.

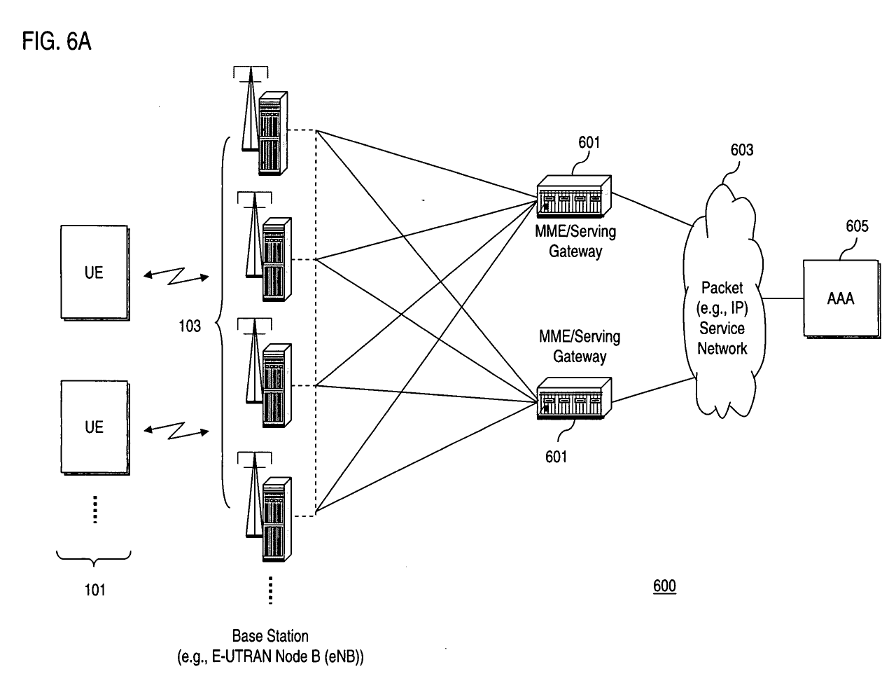

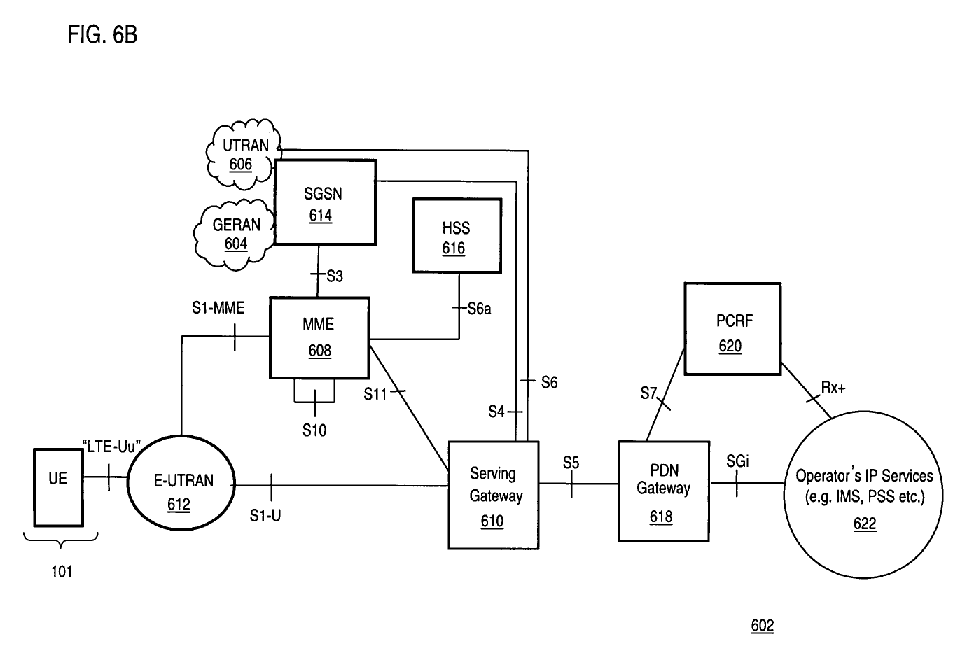

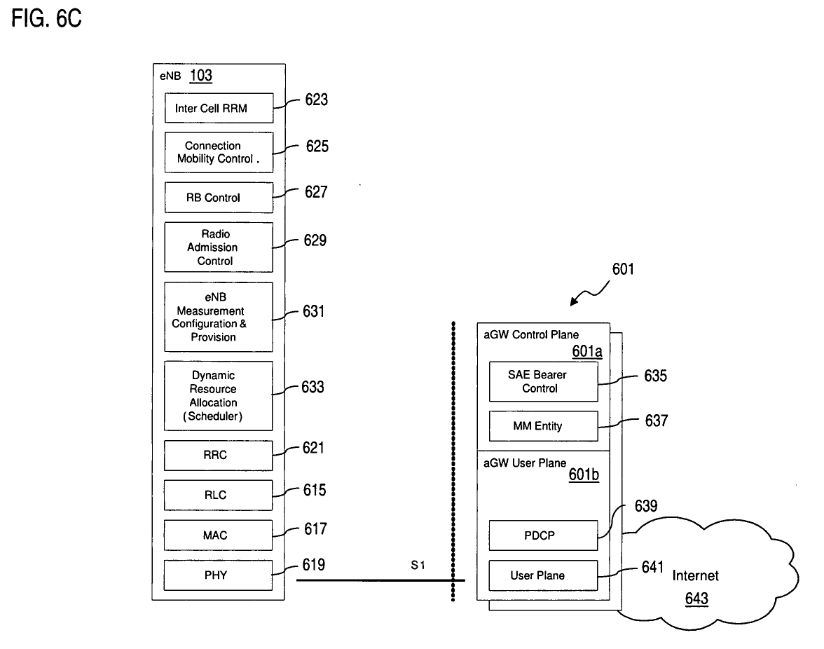

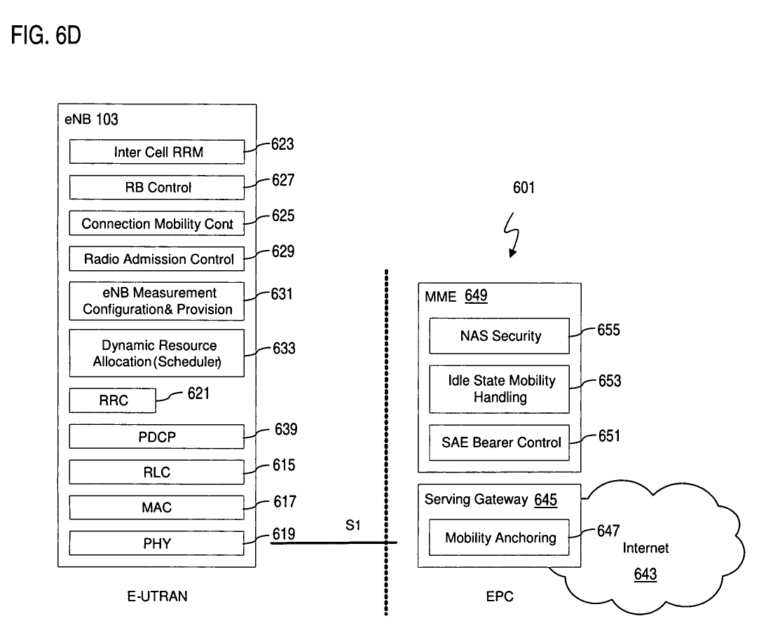

FIG. 1 is a diagram of a communication system capable of system information, according to an exemplary embodiment. As shown in FIG. 1, one or more user equipment (UEs) 101 communicate with a base station 103, which is part of an access network (e.g., 3GPP LTE (or E-UTRAN, etc.). Under the 3GPP LTE architecture (as shown in FIGS. 6A-6D), the base station 103 is denoted as an enhanced Node B (eNB). The UE 101 can be any type of mobile stations, such as handsets, terminals, stations, units, devices, multimedia tablets, Internet nodes, communicators, Personal Digital Assistants (PDAs) or any type of interface to the user (such as “wearable” circuitry, etc.). The UE 101 includes a transceiver 105 and an antenna system 107 that couples to the transceiver 105 to receive or transmit signals from the base station 103. The antenna system 107 can include one or more antennas.

As with the UE 101, the base station 103 employs a transceiver 109, which transmits information to the UE 101. Also, the base station 103 can employ one or more antennas 111 for transmitting and receiving electromagnetic signals. For instance, the Node B 103 may utilize a Multiple Input Multiple Output (MIMO) antenna system 111, whereby the Node B 103 can support multiple antenna transmit and receive capabilities. This arrangement can support the parallel transmission of independent data streams to achieve high data rates between the UE 101 and Node B 103. The base station 103, in an exemplary embodiment, uses OFDM (Orthogonal Frequency Divisional Multiplexing) as a downlink (DL) transmission scheme and a single-carrier transmission (e.g., SC-FDMA (Single Carrier-Frequency Division Multiple Access) with cyclic prefix for the uplink (UL) transmission scheme. SC-FDMA can also be realized using a DFT-S-OFDM principle, which is detailed in 3GGP TR 25.814, entitled “Physical Layer Aspects for Evolved UTRA,” v.1.5.0, May 2006 (which is incorporated herein by reference in its entirety). SC-FDMA, also referred to as Multi-User-SC-FDMA, allows multiple users to transmit simultaneously on different sub-bands.

System 100 provides various channel types: physical channels, transport channels, and logical channels. Physical channels can include a physical downlink shared channel (PDSCH), a dedicated physical downlink dedicated channel (DPDCH), a dedicated physical control channel (DPCCH), etc. The transport channels can be defined by how they transfer data over the radio interface and the characteristics of the data. The transport channels include a broadcast channel (BCH), paging channel (PCH), a dedicated shared channel (DSCH), etc. Other exemplary transport channels are an uplink (UL) Random Access Channel (RACH), Common Packet Channel (CPCH), Forward Access Channel (FACH), Downlink Shared Channel (DLSCH), Uplink Shared Channel (USCH), Broadcast Channel (BCH), and Paging Channel (PCH). A dedicated transport channel is the UL/DL Dedicated Channel (DCH). Each transport channel is mapped to one or more physical channels according to its physical characteristics.

Each logical channel can be defined by the type and required Quality of Service (QoS) of information that it carries. The associated logical channels include, for example, a broadcast control channel (BCCH), a paging control channel (PCCH), Dedicated Control Channel (DCCH), Common Control Channel (CCCH), Shared Channel Control Channel (SHCCH), Dedicated Traffic Channel (DTCH), Common Traffic Channel (CTCH), etc.

The BCCH (Broadcast Control Channel) can be mapped onto both BCH and DSCH. As such, this is mapped to the PDSCH; the time-frequency resource can be dynamically allocated by using L1/L2 control channel (PDCCH). In this case, BCCH (Broadcast Control Channel)-RNTI (Radio Network Temporary Identities) is used to identify the resource allocation information.

Communications between the UE 101 and the base station 103 (and the network 100) is governed, in part, by control information exchanged between the two entities. Such control information, in an exemplary embodiment, is transported over a control channel on, for example, the downlink from the base station 103 to the UE 101. Accordingly, the base station 103 employs a control signaling module 113. It is recognized that one of the problems related to the control channel in general is that it is desirable to transmit as much information as possible to obtain the greatest flexibility, while reducing the need to provide control signaling as much as possible without losing any (or only marginal) system performance in terms of throughput or efficiency.

According to certain embodiments, the base station 103 provides scheduling information only when a repetition rate for the system information is larger than a preset value (or threshold). This threshold can be set depending on the analysis of power savings in the terminals (e.g., UE 101). This analysis can be executed by power saving logic 115, which operates in conjunction with power logic 117 to obtain, in an exemplary embodiment, power information from the UE 101.

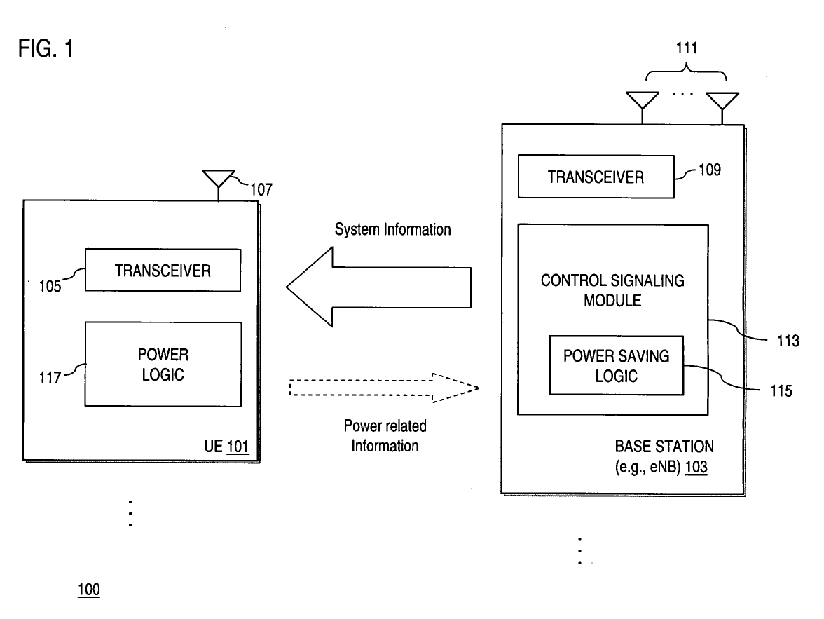

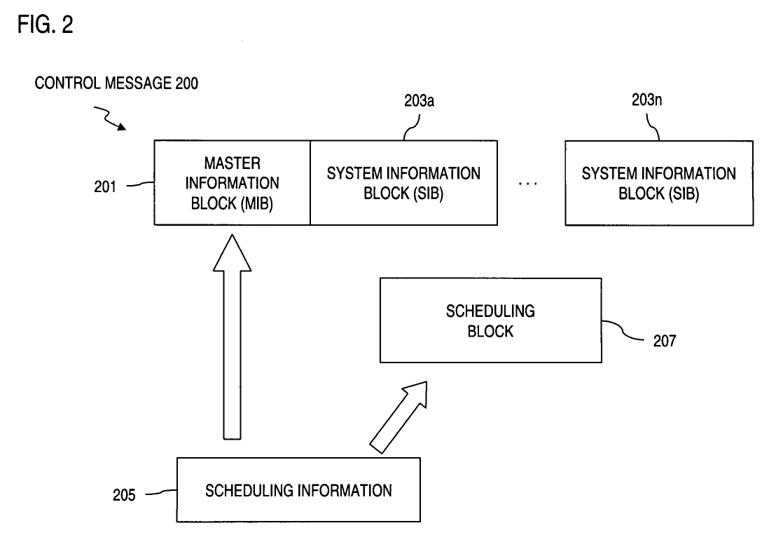

FIG. 2 is a diagram of a control message specifying scheduling information associated with system information, according to an exemplary embodiment. Efficient signaling of system information (SI), such as System Information Blocks (SIB), from the eNB 103 to the UE 101. In one embodiment, such system information can be transmitted to the UE 101 through a control message 200, which can include a Master Information Block (MIB) 201 and one or more System Information Blocks (SIBs) 203a-203n. The MIB 201, for example, provides references and scheduling information 205 for a number of system information blocks 203a-203n. The system information blocks 203a-203n include actual system information. The system information, for example, can indicate usage frequency of a vendor's service. The master information block 201 can specify reference and scheduling information 205 to one or more (e.g., two) scheduling blocks 207, which provide references and scheduling information for additional system information blocks. Scheduling information for a system information block can included in either the master information block or one of the scheduling blocks.

In EUTRAN, scheduling information of System Information Blocks (SIB) 203 can be included in the Master Information Block (MIB) 201 or sent as a separate Scheduling Block (SB) 207. Traditionally, the scheduling information 205 is provided for all SIB's 203a-203n even if this information 205 is not need in the practical User Equipment (UE) software implementations. In practical terms, the repetition (or repeating) rate of many SIB's is usually so frequent that the terminal 101 does not save power by keeping synchronization information of SIB's and possibly powering off the receiver (e.g., transceiver 105) until shortly before the necessary SIB is available on a broadcast channel.

Traditionally, with UTRAN system information (SI) broadcast, the scheduling block 207 is unnecessary large, as it includes scheduling for all SIB's independent of the repetition rate. The UTRAN System Information broadcast structure is detailed in 3GPP TS25.331, entitled “Radio Resource Control (RRC) Protocol Specification,” which is incorporated herein by reference in its entirety. It is recognized that this approach is not efficient with LTE.

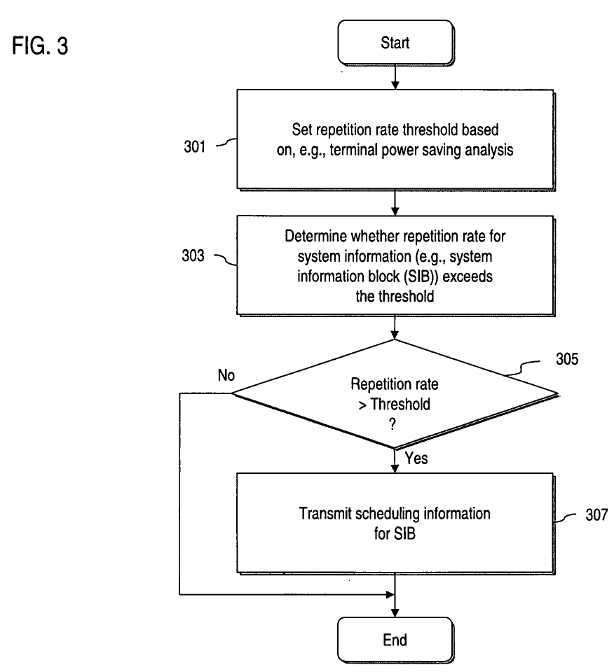

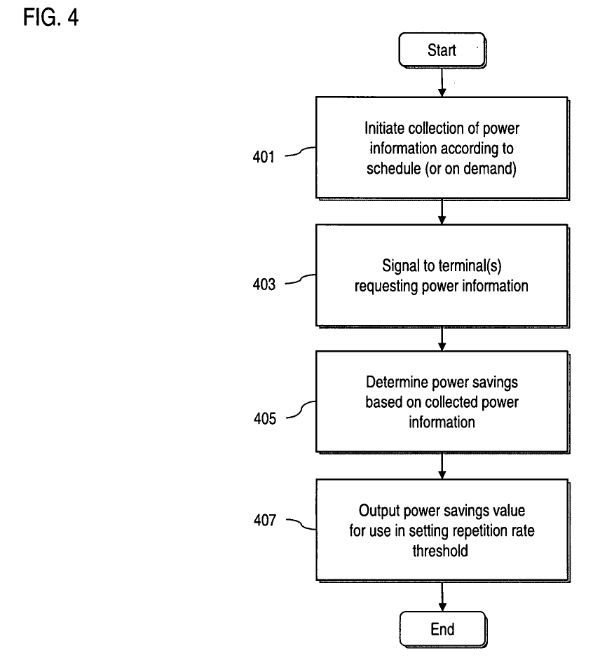

FIG. 3 is a flowchart of a process for transmitting system information based on repetition rate, according to an exemplary embodiment. In view of the signaling inefficiency of the traditional approach, this process utilizes an optimized structure of scheduling information, such that the scheduling information is provided only for the SIB's which are sent with a long enough repetition period. In step 301, the repetition rate is set, for example, based on power saving analysis; this analysis process is more fully described below with respect to FIG. 4.

Next, in step 303, a determination is made whether the repetition rate for the system information (e.g., SIB) exceeds the threshold. If the threshold is exceeded, or otherwise satisfied, (per step 305), the scheduling information for the SIB is transmitted, as in step 307. In other words, scheduling information for SIB's is provided only when the SIB repetition rate is larger than the preset value (or threshold). By way of example, this value is dependent on the analysis of power savings in terminals; e.g., 2 seconds.

The above approach, according to certain embodiments, can save network capacity in, for instance, a downlink shared channel (DLSCH) by avoiding the sending of information that is not necessary for UE operation or improvement of standby times. For instance, if UTRAN system information broadcast is used as a reference, there would be no need to specify any scheduling time, except for special information that uses long repetition periods, such as positioning data.

FIG. 4 is a flowchart of a process for collecting power information to set a repetition rate threshold, according to an exemplary embodiment. In step 401, the process can initiate the gathering of relevant data for performing power savings analysis according to a schedule (e.g., periodically) or based on an on-demand basis. The base station 103 can, as in step 403, signal to the UE 101 to request information regarding, for example, the transmit power level, signal quality, channel parameters, etc. The information can be measured or acquired using the power logic 117 of the UE 101. Alternatively, the base station 103 can gather and/or measure such information on its own. The power saving logic 115 can then compute the power savings that can be obtained by manipulating the repetition rate in relation to the collected information (step 405). In step 407, the power saving logic 115 can output a power savings value that can be used to set the repetition rate threshold value.

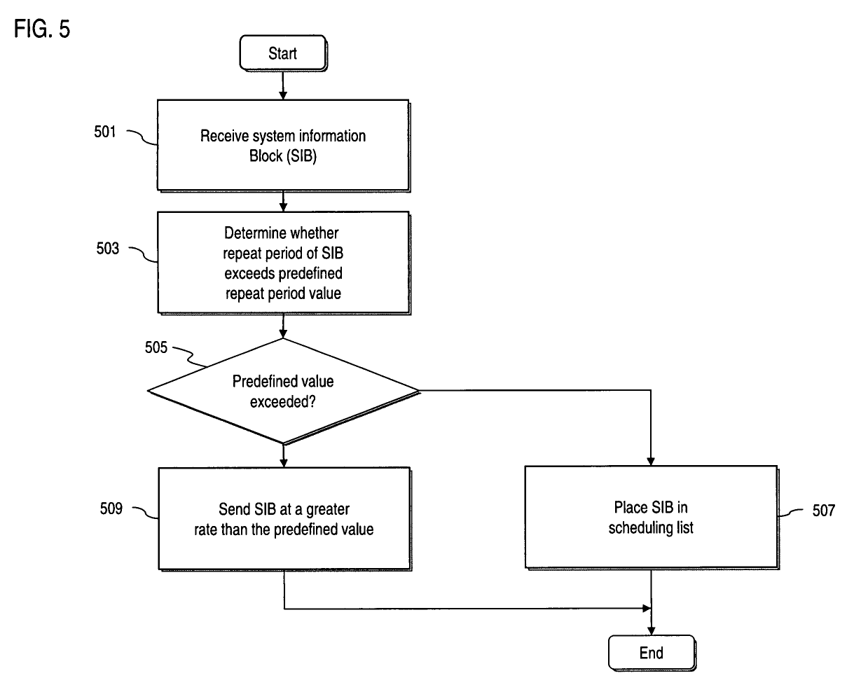

FIG. 5 is a flowchart of a process for creating a scheduling list relating to transmission of system information, according to an exemplary embodiment. According to one embodiment, a scheduling list specifies scheduling times only for SIB's for which the repeat period is longer than a preset optimization value, or threshold, e.g., 2 seconds. The predefined value can be fixed in the specification or possibly vendor/operator specific. In an exemplary embodiment, the value is broadcasted in the system information so that the UE 101 knows the maximum repetition rate of the SIBs. In step 501, system information block is received, and used to determine whether the repetition or repeat period of the system information block exceeds a predefined repeat period value, as in step 503.

If the predefined value (step 505) is exceeded, the SIB is placed in the scheduling list (step 507). However, SIBs not placed in the scheduling list are sent more frequently than predefined value, per step 509.

As mentioned, the above processes can be performed within an UMTS terrestrial radio access network (UTRAN) or Evolved UTRAN (E-UTRAN) in 3GPP, as next described.

FIGS. 6A-6D are diagrams of communication systems having exemplary long-term evolution (LTE) architectures, in which the user equipment (UE) and the base station of FIG. 1 can operate, according to various exemplary embodiments of the invention. By way of example (shown in FIG. 6A), a base station (e.g., destination node) and a user equipment (UE) (e.g., source node) can communicate in system 600 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both uplink and downlink can utilize WCDMA. In another exemplary embodiment, uplink utilizes SC-FDMA, while downlink utilizes OFDMA.

The communication system 600 is compliant with 3GPP LTE, entitled “Long Term Evolution of the 3GPP Radio Technology” (which is incorporated herein by reference in its entirety). As shown in FIG. 6A, one or more user equipment (UEs) communicate with a network equipment, such as a base station 103, which is part of an access network (e.g., WiMAX (Worldwide Interoperability for Microwave Access), 3GPP LTE (or E-UTRAN), etc.). Under the 3GPP LTE architecture, base station 103 is denoted as an enhanced Node B (eNB).

MME (Mobile Management Entity)/Serving Gateways 601 are connected to the eNBs 103 in a full or partial mesh configuration using tunneling over a packet transport network (e.g., Internet Protocol (IP) network) 603. Exemplary functions of the MME/Serving GW 601 include distribution of paging messages to the eNBs 103, termination of U-plane packets for paging reasons, and switching of U-plane for support of UE mobility. Since the GWs 601 serve as a gateway to external networks, e.g., the Internet or private networks 603, the GWs 601 include an Access, Authorization and Accounting system (AAA) 605 to securely determine the identity and privileges of a user and to track each user's activities. Namely, the MME Serving Gateway 601 is the key control-node for the LTE access-network and is responsible for idle mode UE tracking and paging procedure including retransmissions. Also, the MME 601 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 6B, a communication system 602 supports GERAN (GSM/EDGE radio access) 604, and UTRAN 606 based access networks, E-UTRAN 612 and non-3GPP (not shown) based access networks, and is more fully described in TR 23.882, which is incorporated herein by reference in its entirety. A key feature of this system is the separation of the network entity that performs control-plane functionality (MME 608) from the network entity that performs bearer-plane functionality (Serving Gateway 610) with a well defined open interface between them 511. Since E-UTRAN 612 provides higher bandwidths to enable new services as well as to improve existing ones, separation of MME 608 from Serving Gateway 610 implies that Serving Gateway 610 can be based on a platform optimized for signaling transactions. This scheme enables selection of more cost-effective platforms for, as well as independent scaling of, each of these two elements. Service providers can also select optimized topological locations of Serving Gateways 610 within the network independent of the locations of MMEs 608 in order to reduce optimized bandwidth latencies and avoid concentrated points of failure.

As seen in FIG. 6B, the E-UTRAN (e.g., eNB) 612 interfaces with UE 101 via LTE-Uu. The E-UTRAN 612 supports LTE air interface and includes functions for radio resource control (RRC) functionality corresponding to the control plane MME 608. The E-UTRAN 612 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 608, as a key control node, is responsible for managing mobility UE identifies and security parameters and paging procedure including retransmissions. The MME 608 is involved in the bearer activation/deactivation process and is also responsible for choosing Serving Gateway 610 for the UE 101. MME 608 functions include Non Access Stratum (NAS) signaling and related security. MME 608 checks the authorization of the UE 101 to camp on the service provider's Public Land Mobile Network (PLMN) and enforces UE 101 roaming restrictions. The MME 608 also provides the control plane function for mobility between LTE and 2G/3G access networks with the S3 interface terminating at the MME 608 from the SGSN (Serving GPRS Support Node) 614.

The SGSN 614 is responsible for the delivery of data packets from and to the mobile stations within its geographical service area. Its tasks include packet routing and transfer, mobility management, logical link management, and authentication and charging functions. The S6a interface enables transfer of subscription and authentication data for authenticating/authorizing user access to the evolved system (AAA interface) between MME 608 and HSS (Home Subscriber Server) 616. The S10 interface between MMEs 608 provides MME relocation and MME 608 to MME 608 information transfer. The Serving Gateway 610 is the node that terminates the interface towards the E-UTRAN 612 via S1-U.

The S1-U interface provides a per bearer user plane tunneling between the E-UTRAN 612 and Serving Gateway 610. It contains support for path switching during handover between eNBs 103. The S4 interface provides the user plane with related control and mobility support between SGSN 614 and the 3GPP Anchor function of Serving Gateway 610.

The S12 is an interface between UTRAN 606 and Serving Gateway 610. Packet Data Network (PDN) Gateway 618 provides connectivity to the UE 101 to external packet data networks by being the point of exit and entry of traffic for the UE 101. The PDN Gateway 618 performs policy enforcement, packet filtering for each user, charging support, lawful interception and packet screening. Another role of the PDN Gateway 618 is to act as the anchor for mobility between 3GPP and non-3GPP technologies such as WiMax and 3GPP2 (CDMA 1× and EvDO (Evolution Data Only)).

The S7 interface provides transfer of QoS policy and charging rules from PCRF (Policy and Charging Role Function) 620 to Policy and Charging Enforcement Function (PCEF) in the PDN Gateway 618. The SGi interface is the interface between the PDN Gateway and the operator's IP services including packet data network 622. Packet data network 622 may be an operator external public or private packet data network or an intra operator packet data network, e.g., for provision of IMS (IP Multimedia Subsystem) services. Rx+ is the interface between the PCRF and the packet data network 622.

As seen in FIG. 6C, the eNB 103 utilizes an E-UTRA (Evolved Universal Terrestrial Radio Access) (user plane, e.g., RLC (Radio Link Control) 615, MAC (Media Access Control) 617, and PHY (Physical) 619, as well as a control plane (e.g., RRC 621)). The eNB 103 also includes the following functions: Inter Cell RRM (Radio Resource Management) 623, Connection Mobility Control 625, RB (Radio Bearer) Control 627, Radio Admission Control 629, eNB Measurement Configuration and Provision 631, and Dynamic Resource Allocation (Scheduler) 633.

The eNB 103 communicates with the aGW 601 (Access Gateway) via an S1 interface. The aGW 601 includes a User Plane 601a and a Control plane 601b. The control plane 601b provides the following components: SAE (System Architecture Evolution) Bearer Control 635 and MM (Mobile Management) Entity 637. The user plane 601b includes a PDCP (Packet Data Convergence Protocol) 639 and a user plane functions 641. It is noted that the functionality of the aGW 601 can also be provided by a combination of a serving gateway (SGW) and a packet data network (PDN) GW. The aGW 601 can also interface with a packet network, such as the Internet 643.

In an alternative embodiment, as shown in FIG. 6D, the PDCP (Packet Data Convergence Protocol) functionality can reside in the eNB 103 rather than the GW 601. Other than this PDCP capability, the eNB functions of FIG. 6C are also provided in this architecture.

In the system of FIG. 6D, a functional split between E-UTRAN and EPC (Evolved Packet Core) is provided. In this example, radio protocol architecture of E-UTRAN is provided for the user plane and the control plane. A more detailed description of the architecture is provided in 3GPP TS 86.300.

The eNB 103 interfaces via the S1 to the Serving Gateway 645, which includes a Mobility Anchoring function 647. According to this architecture, the MME (Mobility Management Entity) 649 provides SAE (System Architecture Evolution) Bearer Control 651, Idle State Mobility Handling 653, and NAS (Non-Access Stratum) Security 655.

One of ordinary skill in the art would recognize that the processes for performing cell searches may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

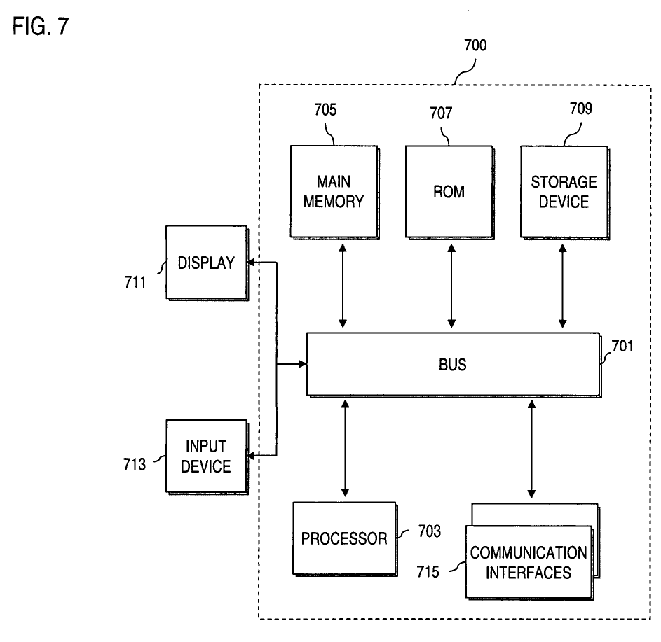

FIG. 7 illustrates exemplary hardware upon which various embodiments of the invention can be implemented. A computing system 700 includes a bus 701 or other communication mechanism for communicating information and a processor 703 coupled to the bus 701 for processing information. The computing system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computing system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computing system 700 may be coupled via the bus 701 to a display 711, such as a liquid crystal display, or active matrix display, for displaying information to a user. An input device 713, such as a keyboard including alphanumeric and other keys, may be coupled to the bus 701 for communicating information and command selections to the processor 703. The input device 713 can include a cursor control, such as a mouse, a trackball, or cursor direction keys, for communicating direction information and command selections to the processor 703 and for controlling cursor movement on the display 711.

According to various embodiments of the invention, the processes described herein can be provided by the computing system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 700 also includes at least one communication interface 715 coupled to bus 701. The communication interface 715 provides a two-way data communication coupling to a network link (not shown). The communication interface 715 sends and receives electrical, electromagnetic, or optical signals that carry digital data streams representing various types of information. Further, the communication interface 715 can include peripheral interface devices, such as a Universal Serial Bus (USB) interface, a PCMCIA (Personal Computer Memory Card International Association) interface, etc.

The processor 703 may execute the transmitted code while being received and/or store the code in the storage device 709, or other non-volatile storage for later execution. In this manner, the computing system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

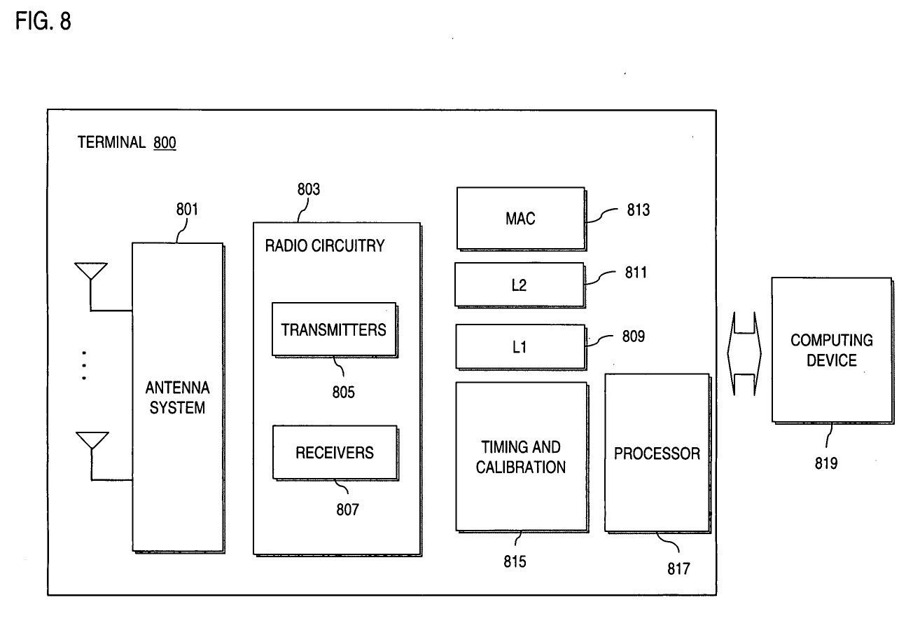

FIG. 8 is a diagram of exemplary components of a user terminal configured to operate in the systems of FIGS. 6A-6D, according to an embodiment of the invention. A user terminal 800 includes an antenna system 801 (which can utilize multiple antennas) to receive and transmit signals. The antenna system 801 is coupled to radio circuitry 803, which includes multiple transmitters 805 and receivers 807. The radio circuitry encompasses all of the Radio Frequency (RF) circuitry as well as base-band processing circuitry. As shown, layer-1 (L1) and layer-2 (L2) processing are provided by units 809 and 811, respectively. Optionally, layer-3 functions can be provided (not shown). Module 813 executes all Medium Access Control (MAC) layer functions. A timing and calibration module 815 maintains proper timing by interfacing, for example, an external timing reference (not shown). Additionally, a processor 817 is included. Under this scenario, the user terminal 800 communicates with a computing device 819, which can be a personal computer, work station, a Personal Digital Assistant (PDA), web appliance, cellular phone, etc.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining whether repetition rate associated with system information exceeds a predetermined threshold, the repetition rate specifying frequency of transmission of the system information to a terminal over a network,
wherein the scheduling information for the system information is transmitted to the terminal if the threshold is satisfied.

2. A method according to claim 1, further comprising:
setting the threshold based on analysis of power savings corresponding to a plurality of terminals in the network.

3. A method according to claim 2, further comprising:
collecting power information from the terminals to perform the analysis.

4. A method according to claim 1, wherein the system information is sent over a downlink shared channel to the terminal.

5. A method according to claim 1, wherein the system information includes a system information block (SIB).

6. A method according to claim 5, wherein the system information block is included either as part of a master information block (MIB) or in a separate scheduling block (SB).

7. A method according to claim 1, wherein the network is compliant with a long term evolution (LTE)-compliant architecture, and provides wideband code division multiple access (WCDMA).

8. A method according to claim 1, further comprising:
transmitting the scheduling information over the network to the terminal if the threshold is satisfied.

9. A computer-readable storage medium carrying one or more sequences of one or more instructions which, when executed by one or more processors, cause the one or more processors to perform the method of claim 1.

10. An apparatus comprising:
logic configured to determine whether repetition rate associated with system information exceeds a predetermined threshold, the repetition rate specifying frequency of transmission of the system information to a terminal over a network,
wherein the scheduling information for the system information is transmitted to the terminal if the threshold is satisfied.

11. An apparatus according to claim 10, wherein the logic is further configured to set the threshold based on analysis of power savings corresponding to a plurality of terminals in the network.

12. An apparatus according to claim 11, wherein the logic is further configured to initiate collection of power information from the terminals to perform the analysis.

13. An apparatus according to claim 10, wherein the system information is sent over a downlink shared channel to the terminal.

14. An apparatus according to claim 10, wherein the system information includes a system information block (SIB).

15. An apparatus according to claim 14, wherein the system information block is included either as part of a master information block (MIB) or in a separate scheduling block (SB).

16. An apparatus according to claim 10, wherein the network is compliant with a long term evolution (LTE)-compliant architecture, and provides wideband code division multiple access (WCDMA).

17. An apparatus according to claim 10, further comprising:
a transceiver configured to transmit the scheduling information over the network to the terminal if the threshold is satisfied.

18. A method comprising:
transmitting power information over a network to a base station; and
receiving scheduling information for system information from the base station, wherein repetition rate associated with system information exceeds a predetermined threshold that is set based on a power saving analysis using the power information.

19. A method according to claim 18, further comprising:
receiving the system information over a downlink shared channel.

20. A method according to claim 18, wherein the system information includes a system information block (SIB).

21. A method according to claim 20, wherein the system information block is included either as part of a master information block (MIB) or in a separate scheduling block (SB).

22. A computer-readable storage medium carrying one or more sequences of one or more instructions which, when executed by one or more processors, cause the one or more processors to perform the method of claim 18.

23. An apparatus comprising:
logic configured to generate power information for transmission over a network to a base station,
wherein scheduling information for system information is received from the base station, and repetition rate associated with system information exceeds a predetermined threshold that is set based on a power saving analysis using the power information.

24. An apparatus according to claim 23, further comprising:
a transceiver configured to receive the system information over a downlink shared channel.

25. An apparatus according to claim 23, wherein the system information includes a system information block (SIB).

26. An apparatus according to claim 25, wherein the system information block is included as part of a master information block (MIB) or in a separate scheduling block (SB).
